(19) United States
(12) Patent Application Publication
(10) Pub. No.: US 2013/0216994 A1
(43) Pub. Date: Aug. 22, 2013

(54) System and Method for Virtual Textbook Creation and Remuneration

(71) Applicants: Kevin Howard Eaton, Salem, NH (US); Halldor Festvaag Utne, Beverly, MA (US); Joakim F. Lindblom, Atherton, CA (US)

(72) Inventors: Kevin Howard Eaton, Salem, NH (US); Halldor Festvaag Utne, Beverly, MA (US); Joakim F. Lindblom, Atherton, CA (US)

(21) Appl. No.: 13/585,948

(22) Filed: Aug. 15, 2012

Related U.S. Application Data
(60) Provisional application No. 61/524,285, filed on Aug. 16, 2011.

(51) Int. Cl. G09B 5/00

(52) U.S. Cl. CPC G09B 5/00
USPC 434/365

(57) ABSTRACT

A system and a method for creating virtual textbooks and other educational collections by assembling content sections from multiple online resources, and remunerating the authors for their contributions. The system allows curators to assemble online multimedia textbooks by selecting, cross-publishing and organizing content components from a) online collections crowdsourced from expert contributors or b) posted by textbook publishers for the purposes of re-mixing into new online educational resources. Students or other purchasers may then purchase these textbooks/educational resources directly. or they me be selected and customized by professors/teachers as required materials for their students for purchase when taking their course. Once a textbook/educational resource is purchased by a student, all stakeholders in the system (authors, contributors, curators, etc.) are automatically compensated for their contributions in accordance to their specified fee which is reflected as part of the final purchase price that purchasers pay.

This application is related to and claims priority from U.S. Provisional patent application No. 61/524,285 filed Aug. 16, 2011. Application 61/524,285 is hereby incorporated by reference.

### BACKGROUND

1. Field of the Invention

The present invention relates to information management and more particularly to a system and method that provides and manages virtual textbook creation, distribution and remuneration.

2. Description of the Prior Art

There are generally two main motivations behind experts writing content for textbooks . . . an altruistic desire to share their knowledge with students and a material need to be reimbursed for their value and effort. There also are often requirements from employer institutions such as universities as well as career advancement pressures to publish.

The typical time required to produce a textbook for use in a classroom is over three years. In some fields of study, the industry changes so rapidly that these textbooks are obsolete the moment they are printed, and sometimes they possess little value as a result. Would-be authors of these textbooks fear that they might lose some credibility and be viewed as out-of-date.

In addition, while textbooks typically need to cover a wide range of topics in a discipline, it is difficult to find authors in today's world of specialization that cover the necessary range of topics with sufficient depth. On the other hand, attempting to co-ordinate a larger number of topic experts in collaboratively writing a single textbook with conventional production methods is logistically difficult-to-impossible.

Hardcover textbooks also have the major disadvantage that errors cannot be corrected until the next edition, if any (hence the issuance of errata sheets), and new material, or a change to the existing material, is impossible to insert and again must wait until the next edition. With some books, especially in fields such as law where change is continuous, yearbooks containing only changes and updates are published between editions. This is a totally unsatisfactory solution since even the yearbooks are usually a year or more behind the actual changes taking place.

Another disadvantage of a hardcover textbook for a class is its high cost. The cost of 4-9 new (or even used) college textbooks is a major obstacle to many students. The situation is made worse by the fact that in many classes, only a portion (sometimes only a very small portion) of the book is used. It is very difficult to find a college class that finished a textbook from cover to cover.

Finally, in today's world of online multimedia information delivery and social media, the conventional textbook format—even when delivered in an online format—is becoming increasingly outdated.

It would be extremely advantageous to have a platform where multiple authors can contribute and collaboratively organize and present material in an online multimedia textbook format, and where they can control their contributions while they are being used including updating them and correcting them based both on new developments in the field as well as real-time feedback and analytics of how their contributions are being used in the classroom. This platform should provide a way for authors to be fairly compensated for their contributions and prevent rote copying by students or readers who would rather not pay for the material. The platform should also provide a way for a professor or other organizer to pick and choose material that will actually be used in a class, providing citation to the author and fair compensation for the use.

### SUMMARY OF THE INVENTION

The present invention relates to a virtual textbook system platform located on least one server and accessible over a network by a number of users that contains content storage where authors can enter, change and update material as well as setting a price on the material itself. Curator access support allows a curator to gather portions of the content from multiple authors and online collections into an online multimedia virtual textbook and set a base price for this virtual textbook. The system also can contain a management support system used by a platform manager, which stores and manages numerous content and virtual textbooks and controls distribution and pricing. Distribution can be performed directly to students, or through professors selecting a textbook and incorporation of it into their class. Students can access the virtual textbook or the individual content either free or by paying a particular price that may include a management charge by the platform manager. Authors get real-time access to feedback analytics on how their content is being used in the classroom which guides them in making updates and improvements to the content. Updates and improvements made by authors can be routed through an online editorial quality workflow process, and once these improvements are approved, all textbooks and classrooms that incorporate this material instantly and automatically receive the updates.

### DESCRIPTION OF THE FIGURES

Attention is drawn to several drawings that illustrate features in the present invention:

FIG. 1 shows one embodiment of a process by which a textbook can be developed according to the present invention.

FIG. 2 shows a numerical example of the process from FIG. 1.

FIG. 3 shows a hierarchical stack that can support embodiments of the present invention.

FIG. 4 shows hardware the can be used to implement embodiments of the present invention.

Several drawings and illustrations have been provided to aid in understanding the present invention. The scope of the present invention is not limited to what is shown in the figures.

### DESCRIPTION OF THE PREFERRED EMBODIMENT

As previously stated, the typical cycle to produce a textbook for use in a classroom is over three years. In some fields of study, changes occur so rapidly that these textbooks may be obsolete the moment they are printed. The present invention allows authors to publish material that is engaging, informative and leading edge. It also provides the authors an opportunity for more rapid reimbursement for their efforts.

The present invention relates to a virtual textbook model. This model introduces a new player in textbook generation—the curator. Perhaps this is more accurately the role that teachers and professors play today, but for which they generally receive no direct remuneration. These individuals typically research textbooks for use in their classrooms and select portions of each book as assigned reading material. The present invention allows teachers and professors to select the best content from a multitude of authors and build, or curate, a textbook for use in their class.

Authors create content on a web platform according to the present invention in the form of text, pictures, video, etc. This platform is typically stored on one or more servers and is accessible remotely over a network such as the Internet. The storage and function may be distributed across several sites or locations. Authors may collaborate to create the content, or they may work alone. The authors can make their content free for use by all students and free for curators to use in creating virtual textbooks if they desire, or they can charge a fee for some use in a virtual textbook while possibly making it free to particular individual students or groups of students. Alternatively, authors can charge a fee for access to any content within a collection. This is a way of creating a virtual textbook without a curator.

Students typically have the ability to access free content directly. While it may appear that a student could circumvent the whole virtual textbook system of the present invention by accessing the individual content components free rather than buying the curated textbook, this will not generally allow them to participate in the classroom as the teacher will bundle textbook within a learning management system (LMS). This is a system that bundles all of the materials needed for a particular class or classes into a coherent whole.

The LMS includes functions such as the ability to build a curriculum, issue assignments to students, accept assignments (e.g. term papers) from students, deliver quizzes and exams, automatically grade quizzes and exams, post comments, conduct forum discussions, blog, send emails and messages, maintain a personal portfolio of work, social sharing through Facebook, LinkedIn, Twitter and more.

The curator normally selects the individual content to curate a textbook. Some of the content will be free, and some will have a charge. The system can keep a running total of the textbook charge as the book is curated. The curator can add his or her own fee to the cost of the virtual textbook. This is not a charge for the content, but rather remuneration for the effort of researching and curating the content. The platform manager can also add a fee for the ability to create and host the virtual textbook and its content.

An author may choose to charge for all or part his or her particular content collection. In this case, the author is acting as both author and curator.

The professor/teacher can then assign the virtual textbook to the class. He can sell the textbook alone or he can bundle it with the LMS. The LMS may be priced as part of the book for the student, or it can be priced for the institution and included in all or a selection of classes.

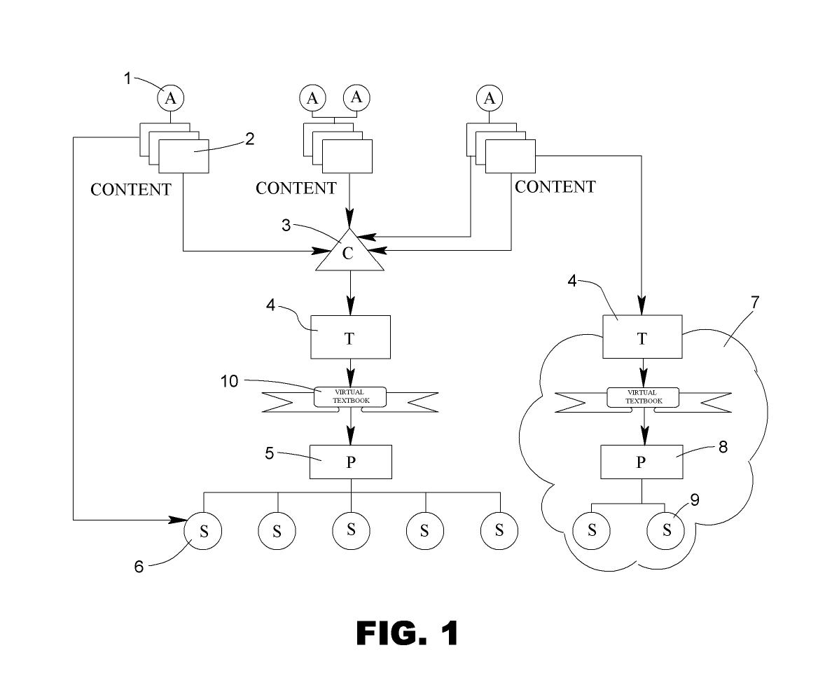

FIG. 1 shows how a textbook may be developed under embodiments of the present invention. Authors 1 develop or otherwise supply content 2. This content can be made available for anyone on the platform. The curator 3, desiring to create a virtual textbook 10, can access any material on the platform combining it into a textbook that can then itself be placed on the platform 4 as a separate entity or collection. The professor or teacher 5 can then make the virtual textbook available to students 6. Alternatively, particular content 2 can be made part of an LMS 7 on the platform 4 that a professor 8 can make available to particular students 9 either as a virtual textbook or containing other information or separately.

The roles of author, curator and professor/teacher can alternatively all be played by the same person. The incentive for the professor/teacher to play all roles is that he or she often has control over assigning required reading and can guarantee at least some sales of his content and curation efforts. This is a process according to the present invention by which professors/teachers can make extra income without the effort, time and risk of writing a lengthy textbook.

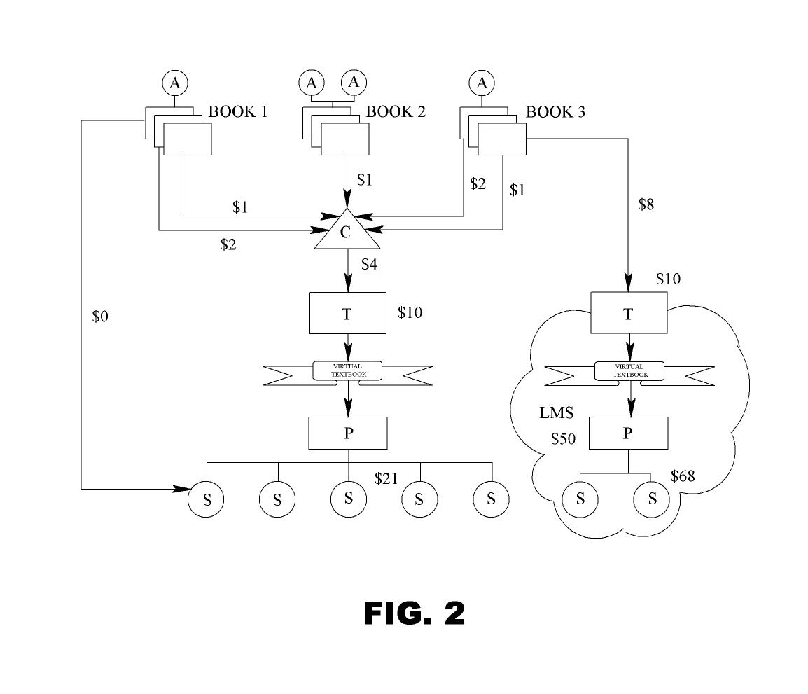

FIG. 2 shows a numerical example of the process of FIG. 1. For Book 1, the first curator has selected content that costs $7 in total. Author 1 will receive $3 while authors 2 and 3 will split $1. The author who has curated his own book will receive $3 per sale of virtual textbook book 1. The curator has chosen to add a fee of $4 for his effort in researching the best material for his students, and platform manager has added a fixed charge of $10. The result is that each student will pay $21 for the use of the virtual textbook.

The author of book 2 has acted as his own curator and charges $8 for his efforts. The platform manager again adds a fixed fee of $10 for the virtual textbook and adds another fixed fee of $50 to bundle it with a learning management system (LMS). This could be a case of a professor who wishes to take advantage of the content on the platform and the benefits of managing his class with the LMS, but doesn't want to wait until the entire university decides to buy the LMS from the platform manager. Author 2 gains the benefits of offering his students a charge that is approximately half of the cost of a hard copy textbook.

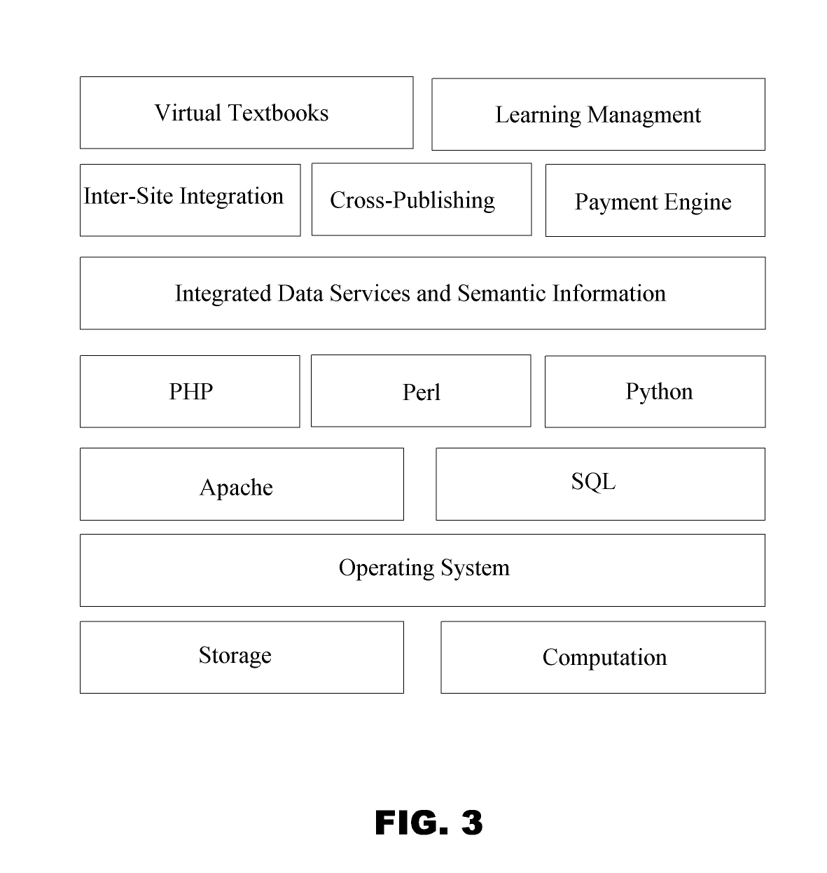

This invention may be implemented in hardware and software in several ways. What follows is a description of the preferred embodiment. FIG. 3 illustrates an embodiment of a logical software stack. Virtual Textbooks are implemented in the application layer (along with LMS functionality) and comprise a collection of content entries (articles, images, videos and other content objects) that are implemented as resources within the data services information core. The resources are attached to one or more topic objects, which also exist in the information core. The topic objects are organized hierarchically which serves to define the virtual textbook organization and scope. The information core in turn is defined as software objects (in this embodiment coded in the PHP, PERL and Python programming languages) and database objects (in this embodiment implemented within a SQL database). When an author or curator sets up the structure and scope of a knowledge collection (such as virtual textbook), they activate software within the dynamic taxonomy software code module which in turn defines scope, organization, hierarchy and user permissions with the database. When a curator cross-publishes content from another collection on the platform they activate the cross publish software module as well as the ecommerce software engine, which makes the content available and sets the component price within the virtual textbook. When a student or other user purchases a textbook (with or without an LMS), the payment engine software module charges the purchaser's credit card and sets permissions within the database to allow the user access to the virtual textbook. All of these software and database components are normally run on servers supported by an operating system (such as Linux or any other operating system) and Web server software (in this embodiment Apache) which receives and sends data to devices on the network including user computers as well as servers.

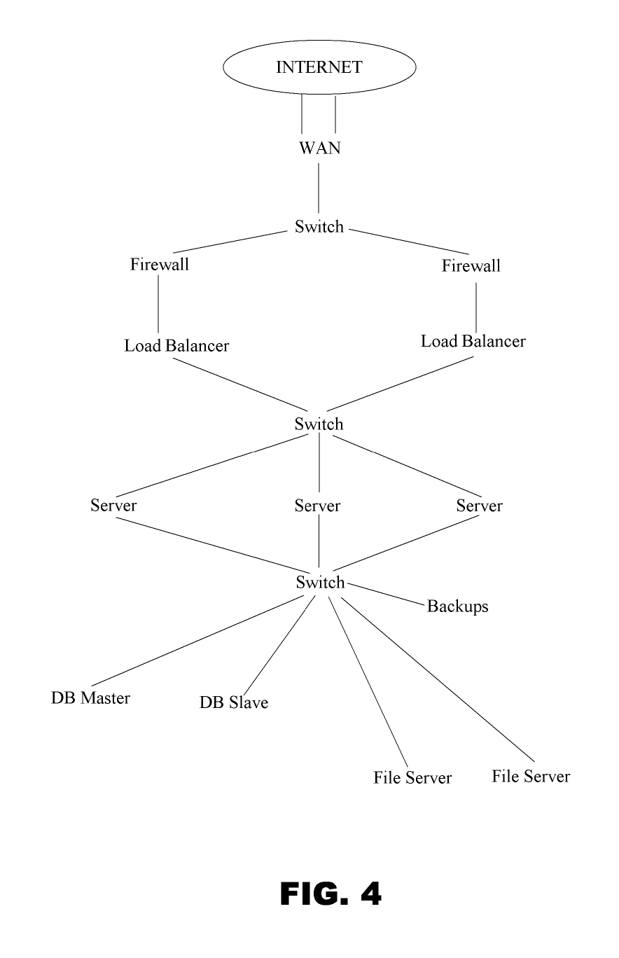

FIG. 4 illustrates a single server farm belonging to a network architecture that can implement the software stack and network functionality. In this embodiment, a request for data or other transaction originates from users' computers on the Internet. The request gets routed to one or more redundant server farms on the Internet such as the one shown in FIG. 4. When the request arrives at a server farm, it gets routed through a firewall and then to one or more application servers through a load balancer. The application server in turn makes the software calculations (using the above software stack) and determines whether data and/or logic action requests exist in the cache. If it exists in the cache, it gets immediately sent to the client computer via the same devices (but in opposite direction) from which the original request was made. If the data and/or logic does not exist within the cache, then the application server makes a request for the data and/or logic from either the database server and/or the file server depending on what kind of request is involved. The result of this request is (1) routed up the chain of devices and connections so that it arrives back at the client computer on the Internet that made the original request, and (2) stores the result of the request in the cache so that the next time the same request is made (within a time limit specified) the result can be served from the cache without involving either the database and/or file server, thus speeding performance.

Several descriptions and illustrations have been presented to aid in understanding the present invention. One with skill in the art will realize that numerous changes and variations are possible without departing from the spirit of the invention. Each of these changes and variations is within the scope of the present invention.

We claim:

1. A virtual textbook system located on a platform on a computer accessible over a network by a plurality of users comprising:
a plurality of content storage areas on said platform wherein authors can enter, change and update content as well as associating a price with said content;
curator access support wherein a curator can gather portions of said content into a virtual textbook and set a base price for said virtual textbook;
management support wherein a platform manager can store said content and said virtual textbook;
student access support wherein a student can access said virtual textbook, either free, or by paying a particular price equal to or greater than said base price.

2. The virtual textbook system of claim 1 wherein once said virtual textbook is purchased, said authors, curator and platform manager are automatically compensated according to predetermined fees.
